(19) United States
(12) Patent Application Publication
(10) Pub. No.: US 2004/0095529 A1
(43) Pub. Date: May 20, 2004

(54) Transflector with integral pushbutton graphics

(76) Inventor: Chris R. Snider, Kokomo, IN (US)

Correspondence Address: STEFAN V. CHMIELEWSKI, DELPHI TECHNOLOGIES, INC., Legal Staff Mail Code CT10C, P.O. Box 9005, Kokomo, IN, 46904-9005, US

(21) Appl. No.: 10/299,925

(22) Filed: Nov. 19, 2002

(51) Int. Cl. G02F 1/1333

(52) U.S. Cl. 349/113; 349/58

(57) ABSTRACT

An electronic control panel includes a display and a transflector. The transflector includes a plurality of integral pushbutton graphics and a display window that provides a reflective background for the display during ambient light conditions and which is translucent when the display is illuminated by a light source.

### TECHNICAL FIELD

The present invention is generally directed to a transflector and, more specifically, to a transflector that includes integral pushbutton graphics.

### BACKGROUND OF THE INVENTION

Various electronic control panels implement displays, e.g., liquid crystal displays (LCDs), with pushbuttons located in relative close proximity to the displays. LCDs that are designed for both daytime and nighttime viewing have generally incorporated a transflector behind the LCD. The transflector provides a reflective surface during non-backlit or daytime ambient light conditions and is usually colored to provide a background for segments or symbols of the LCD for daytime viewing. However, during nighttime conditions, when the LCD is illuminated, the transflector is translucent and, thus, allows the illumination to providing a light background for contrasting dark segments of the LCD.

In such control panels, pushbuttons have been implemented in conjunction with LCDs, which provide a visual feedback of the operation of a device coupled to the control panel. In a typical electronic control panel, pushbuttons generally include identifying graphics and have been constructed with multi-shot materials, with the graphics for the pushbutton in one material or color and the background for the pushbutton in another material or color. Other pushbutton graphics have been created using a laser-etched process to remove paint from a surface of the pushbutton to reveal a contrasting paint or other material.

However, such multi-shot, painted and laser-etched-pushbutton materials are, typically, not easily recycled and generally provide less than desirable styling and color flexibility. As such, it would be desirable to produce an electronic control panel that includes pushbutton graphics that are produced without painting, laser-etching and/or using multiple plastic shots. It would also be desirable for the pushbutton graphic process to simplify the recycling of plastics and increase styling and color flexibility, while providing different appearances on the same basic electronic control panel.

### SUMMARY OF THE INVENTION

An embodiment of the present invention is directed an electronic control panel that includes a display and a transflector. The transflector includes a plurality of integral pushbutton graphics and includes a display window that provides a reflective background for the display in response to ambient light conditions and is translucent when the display is illuminated by a light source.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a perspective assembly view of an electronic control panel, according to one embodiment of the present invention;

FIG. 2 is an exploded view of the electronic control panel of FIG. 1, which includes a transflector with integral pushbutton graphics;

FIG. 3 is a perspective assembly view of an electronic control panel, according to another embodiment of the present invention; and

FIG. 4 is an exploded view of the electronic control panel of FIG. 3, which includes a transflector with integral pushbutton graphics.

### DESCRIPTION OF THE PREFERRED EMBODIMENTS(S)

According to an embodiment of the present invention, a transflector utilizes a base material, such as a polycarbonate film, and includes integral pushbutton graphics, which are, for example, silk screened onto at least one side of the polycarbonate film. Materials, such as a polycarbonate film, allow for light transmission through the material from a controlled illumination source, e.g., back or edge light, that is utilized to illuminate an associated display, e.g., a liquid crystal display (LCD). The color of the pushbutton graphics may be selected to provide a daytime ambient light reflected background for the transflector, which is translucent when the display is illuminated for nighttime conditions.

It should be appreciated that the transflector can be configured in various shapes, when constructed to provide pushbutton graphics for adjacent pushbuttons of an electronic control panel. For example, the transflector may be constructed to include peninsulas that extend from a main display area, i.e., a display window, that is used to provide a display background. It should also be appreciated that the surface of the peninsulas can be decorated with pushbutton function identifying graphics, e.g., an up arrow or a down arrow, including a fan symbol and/or a temperature. As previously stated because the transflector material is translucent, it can be readily back-lit to provide the graphics for the pushbutton.

According to an embodiment of the present invention, the peninsulas of the transflector may be captured between a switch actuator and a clear pushbutton cap. Such a configuration may be utilized in conjunction with a low-travel switch that is consistent with typical control requirements. According to another embodiment, a portion of the transflector may also be captured or placed on a display holder in a pushbutton graphics area. In this case, an actuator may be guided by a display holder structure and an independent pushbutton cap, e.g., a rocker-style pushbutton cap, may interface directly with an actuator and be transparent in select areas for viewing of the pushbutton graphics provided on a portion of the transflector.

Advantageously, such a transflector can be constructed to include peninsulas with pushbutton graphics formed thereon. A main portion, i.e., a display window, of the transflector may be positioned on a display holder and the peninsulas of the transflector can be positioned in an extension of the display holder or, due to the flexibility of the transflector, the peninsulas may be positioned in direct contact with an actuator and captured between the actuator and a pushbutton cap. Back-lighting may be provided in common with a display or independent of the illumination source for the display. Additionally, the LCD holder may be extended to provide support for the pushbutton graphic peninsulas and also provide guides for the pushbutton actuators. It should be appreciated that the pushbutton graphics may be screened or printed on a first surface of the transflector, to simulate the display graphics, and in this manner provide an illusion that the display extends into the pushbutton areas.

Further, in a configuration where the pushbutton graphics are integrated with the transflector, the decoration of both the pushbutton graphics and the display can be readily matched without losing the styling effect of the display. Additionally, the steps of painting, laser-etching and/or multiple plastic shots that has typically been utilized to produce pushbuttons is no longer required, when an electronic control panel is constructed according to the present invention. Further, using a transparent pushbutton cap, which may include selective texturing in areas outside of the graphics viewing area, provides for simplification of recycling of plastics and allows for styling and color flexibility to provide different appearances on the same basic control panel.

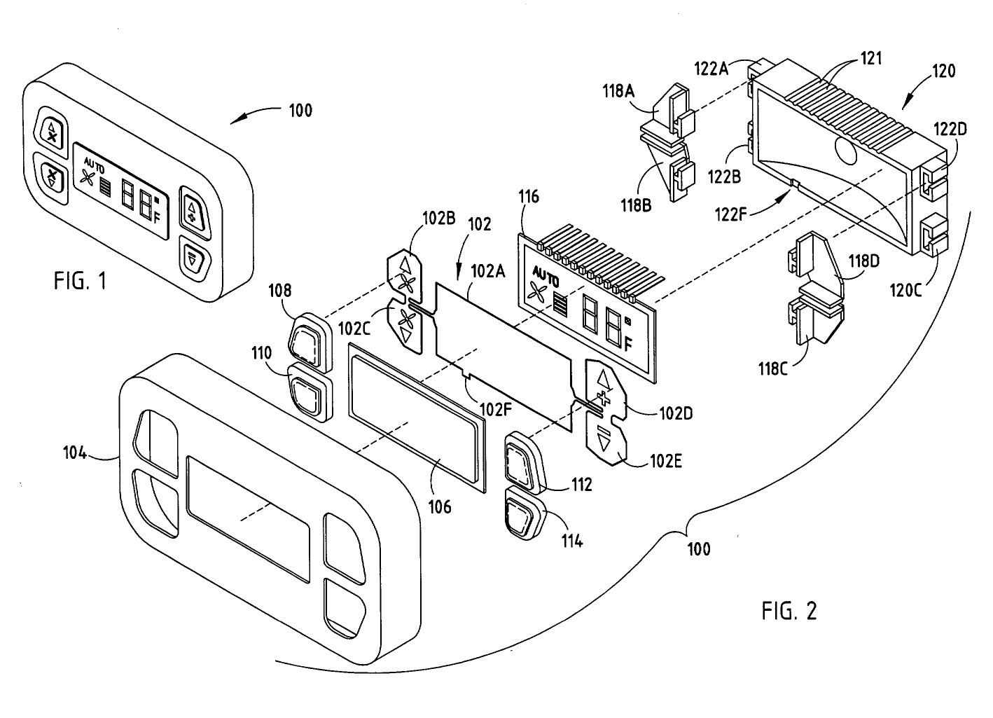

Turning to FIG. 1, an electronic control panel 100, according to one embodiment of the present invention, is illustrated. FIG. 2 provides an exploded view of the panel 100 of FIG. 1. The panel 100 includes a liquid crystal display (LCD) holder 120 that has four integral guides 122A, 122B, 122C and 122D, an error proof transflector tab locator 122F and integral LCD terminal guides 121. The guides 122A-122D receive actuators 118A, 118B, 118C and 118D, respectively. The LCD 116 includes a plurality of pins that are received by the terminal guides 121. A transflector 102, which includes integral pushbutton graphics formed on peninsulas 102B, 102C, 102D and 102E, is positioned between the LCD 116 and trim plate 104, which acts as a housing for the components of the panel 100.

A plurality of pushbutton caps 108, 110, 112 and 114 include clear windows, such that the pushbutton graphics formed on peninsulas 102B, 102C, 102D and 102E are visible to a viewer, at the front of the trim plate 104. The peninsula 102B is captured between the pushbutton cap 108 and the actuator 118A and the peninsula 102C is captured between the pushbutton cap 110 and the actuator 118B. Similarly, the peninsula 102D is captured between the pushbutton cap 112 and the actuator 118D and the peninsula 102E is captured between the pushbutton 114 cap and the actuator 118C. The actuators 118A, 118B, 118C and 118D are received by the integral guides 102A, 102B, 102C and 102D, respectively, which are integrated along a periphery of the LCD holder 120. A lens 106 is positioned along the main display portion of the LCD 116. A main display portion 102A of the transflector 102 may also include an error proof transflector tab 102F, which is received by the locator 122F formed in the LCD holder 120.

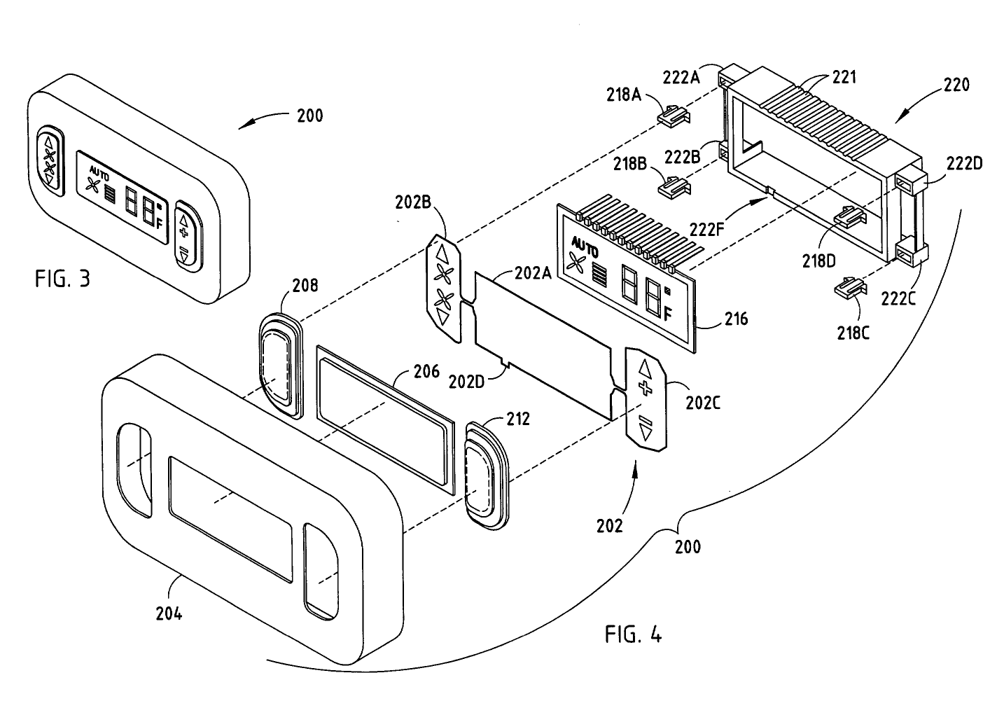

Turning to FIG. 3, an assembly view of an electronic control panel 200, according to another embodiment of the present invention, is illustrated. The panel 200 is similar to the panel 100, with the exception that the panel 200 is directed to a rocker pushbutton assembly. As is shown in FIG. 4, an LCD holder 220 includes four integral guides 222A, 222B, 222C and 222D, which receive snap-in actuators 218A, 218B, 218C and 218D, respectively. An exterior of the LCD holder 220 includes a plurality of LCD terminal guides 221, which receive pins of LCD 216. The LCD holder 220 may also include an error proof transflector tab locator 222F, which allows a transflector 202 to be properly aligned with the LCD holder 220.

The transflector 202 includes a first peninsula 202B and a second peninsula 202C. The first peninsula 202B includes pushbutton graphics, such as a fan symbol with an up/down arrow. The peninsula 202C of the transflector 202 includes up/down arrows and associated plus and minus signs, which facilitate the user to initiate a change in temperature. A lens 206 is positioned in front of the main display portion 202A of the transflector 202. A pushbutton cap 208, which includes a clear window, and may also include texturing, captures the peninsula 202B of the transflector 202 between the actuators 218A and 218B. Similarly, a pushbutton cap 212, which includes a clear window and may also include texturing, captures the peninsula 202C of the transflector 202 between the snap-in actuators 218C and 218D, with a trim plate 204 acting as a housing for the panel 200.

Accordingly, electronic control panels have been described herein, which integrate pushbutton graphics on a transflector that is utilized in conjunction with a display. Such electronic control panels are particularly advantageous in the automotive environment, which requires functionality during both daytime and nighttime conditions.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the Doctrine of Equivalents.

What is claimed is:

1. An electronic control panel, comprising:
a display; and
a transflector including a plurality of integral pushbutton graphics, wherein the transflector includes a display window that provides a reflective background for the display during ambient light conditions and which is translucent when the display is illuminated by a light source.

2. The panel of claim 1, wherein the transflector is made of a polycarbonate film that includes a daytime reflective background.

3. The panel of claim 1, wherein the transflector includes an integral locator tab.

4. The panel of claim 1, wherein the transflector includes a plurality of peninsulas each of which include a different integral pushbutton graphic that corresponds to a different pushbutton function.

5. The panel of claim 1, further including:
a display holder for receiving the display and the transflector, wherein the transflector includes an integral locator tab that is received by an integral transflector tab locator formed in the display holder.

6. The panel of claim 1, wherein the display holder includes a plurality of integral actuator receptacles which each receive an actuator for a different pushbutton.

7. The panel of claim 1, wherein the display is a liquid crystal display (LCD) that is at least one of back-lit and edge-lit.

8. An electronic control panel, comprising:
a display;
a transflector including a plurality of integral pushbutton graphics, wherein the transflector includes a display window that provides a reflective background for the display during ambient light conditions and which is translucent when the display is illuminated by a light source; and
a display holder for receiving the display and the transflector.

9. The panel of claim 8, wherein the transflector is made of a polycarbonate film that includes a daytime reflective background.

10. The panel of claim 8, wherein the transflector includes an integral transflector tab locator.

11. The panel of claim 8, wherein the transflector includes a plurality of peninsulas each of which include a different integral pushbutton graphic that corresponds to a different pushbutton function.

12. The panel of claim 8, wherein the transflector includes an integral tab that is received by an integral transflector tab locator formed in the display holder.

13. The panel of claim 8, wherein the display holder includes a plurality of integral actuator receptacles which each receive an actuator for a different pushbutton.

14. The panel of claim 8, wherein the display is one of a liquid crystal display (LCD) that is at least one of back-lit and edge-lit.

15. An electronic control panel, comprising:
a display;
a transflector including a plurality of integral pushbutton graphics, wherein the transflector includes a display window that provides a reflective background for the display during ambient light conditions and which is translucent when the display is illuminated by a light source; and
a display holder for receiving the display and the transflector, wherein the display is a liquid crystal display (LCD) that is at least one of back-lit and edge-lit.

16. The panel of claim 15, wherein the transflector is made of a polycarbonate film that includes a daytime reflective background.

17. The panel of claim 15, wherein the transflector includes an integral locator tab.

18. The panel of claim 15, wherein the transflector includes a plurality of peninsulas each of which include a different integral pushbutton graphic that corresponds to a different pushbutton function.

19. The panel of claim 15, wherein the transflector includes an integral tab that is received by an integral reflector tab locator formed in the display holder.

20. The panel of claim 15, wherein the display holder includes a plurality of integral actuator receptacles which each receive an actuator for one of the pushbuttons.

21. An electronic control panel, comprising:
a display; and
a transflector including at least one integral pushbutton graphic, wherein the transflector includes a display window that provides a reflective background for the display during ambient light conditions and which is translucent when the display is illuminated by a light source.
